(19) United States
(12) Patent Application Publication
(10) Pub. No.: US 2007/0182335 A1
(43) Pub. Date: Aug. 9, 2007

(54) Methods and apparatus for improving the efficiency of fluorescent lamps

(75) Inventor: Scot Olson, Scottsdale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/350,500

(22) Filed: Feb. 9, 2006

(51) Int. Cl. H01J 61/35; H01J 17/16

(52) U.S. Cl. 313/635

(57) ABSTRACT

Methods and apparatus are provided for increasing the efficiency of a fluorescent lamp suitable for use as a backlight in a liquid crystal display (LCD). The apparatus includes a light producing cavity/channel that encloses a vaporous material that produces an ultraviolet light when electrically excited. A layer of light-emitting material within the channel produces the visible light emitted from the lamp in response to the ultraviolet light, and a faceplate made up of a substantially transparent material is affixed to the cavity to confine the vaporous material. To increase the efficiency of the lamp, a coating is provided on the faceplate that reflects ultraviolet light and transmits visible light. The coating may be applied on either the internal or external surface of the faceplate.

### TECHNICAL FIELD

The present invention generally relates to fluorescent lamps, and more particularly relates to techniques and structures for improving the efficiency of fluorescent lamps such as those used in liquid crystal displays.

### BACKGROUND

A fluorescent lamp is any light source in which a fluorescent material transforms ultraviolet or other lower wavelength energy into visible light. Typically, fluorescent lamps include a glass or plastic tube that is filled with argon or other inert gas, along with mercury vapor or the like. When an electrical current is provided to the contents of the tube, the resulting arc causes the mercury gas within the tube to emit ultraviolet radiation, which in turn excites phosphors located on the inside lamp wall to produce visible light. Fluorescent lamps have provided lighting in numerous home, business and industrial settings for many years.

More recently, fluorescent lamps have been used as backlights in liquid crystal displays such as those used in computer displays, cockpit avionics, and the like. Such displays typically include any number of pixels arrayed in front of a relatively flat fluorescent light source. By controlling the light passing from the backlight through each pixel, color or monochrome images can be produced in a manner that is relatively efficient in terms of physical space and electrical power consumption. Despite the widespread adoption of displays and other products that incorporate fluorescent light sources, however, designers continually aspire to improve the amount of light produced by the light source, to extend the life of the light source, and/or to otherwise enhance the performance of the light source, as well as the overall performance of the display.

Accordingly, it is desirable to provide a fluorescent lamp and associated methods of building and/or operating the lamp that improve the performance and lifespan of the lamp. Other desirable features and characteristics will become apparent from the subsequent detailed description of the invention and the appended claims, taken in conjunction with the accompanying drawings and this background of the invention.

### BRIEF SUMMARY

In various embodiments, methods and apparatus are provided for increasing the efficiency of a fluorescent lamp suitable for use as a backlight in a liquid crystal display (LCD). One embodiment of a fluorescent lamp includes a light producing cavity/channel that encloses a vaporous material that produces an ultraviolet light when electrically excited. A layer of light-emitting material within the channel produces the visible light emitted from the lamp in response to the ultraviolet light, and a faceplate made up of a substantially transparent material is affixed to the cavity to confine the vaporous material. To increase the efficiency of the lamp, a coating is provided on the faceplate that reflects ultraviolet light and transmits visible light. The coating may be applied on either the internal or external surface of the faceplate as appropriate for the particular faceplate.

In another embodiment, a method of making a fluorescent lamp suitable for use in a liquid crystal display includes the broad steps of forming a layer of phosphor material within at least a portion of the channel to thereby create a light-emitting layer, preparing a faceplate comprising a substantially transparent material with a reflective coating disposed thereon, wherein the reflective coating is substantially transmissive of visible light but substantially reflective of ultraviolet light, and affixing the faceplate to the channel.

Other embodiments include other lamps or displays incorporating structures and/or techniques described herein. Additional detail about various exemplary embodiments is set forth below.

### BRIEF DESCRIPTION OF THE DRAWINGS

The present invention will hereinafter be described in conjunction with the following drawing figures, wherein like numerals denote like elements, and

FIG. 1 is an exploded perspective view of an exemplary flat panel display;

FIG. 2 is a side view of an exemplary channel assembly suitable for use in an exemplary fluorescent light source;

FIG. 3 is a side view of an exemplary aperture lamp having ultraviolet-reflective coatings.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Various techniques for improving the efficiency, lifespan or other performance aspect of a fluorescent light source are described herein. These techniques include, for example, applying a layer of ultraviolet-reflective material to the faceplate to reduce losses of UV radiation that would otherwise exit through the transparent aperture. While the various concepts and structures described herein can be combined in various ways, it is not necessary that each improvement described herein be implemented in all embodiments. Conversely, each of the various techniques and structures described herein may be readily applied to all types of fluorescent light sources, including so-called “aperture lamps”, “flat lamps” and the like.

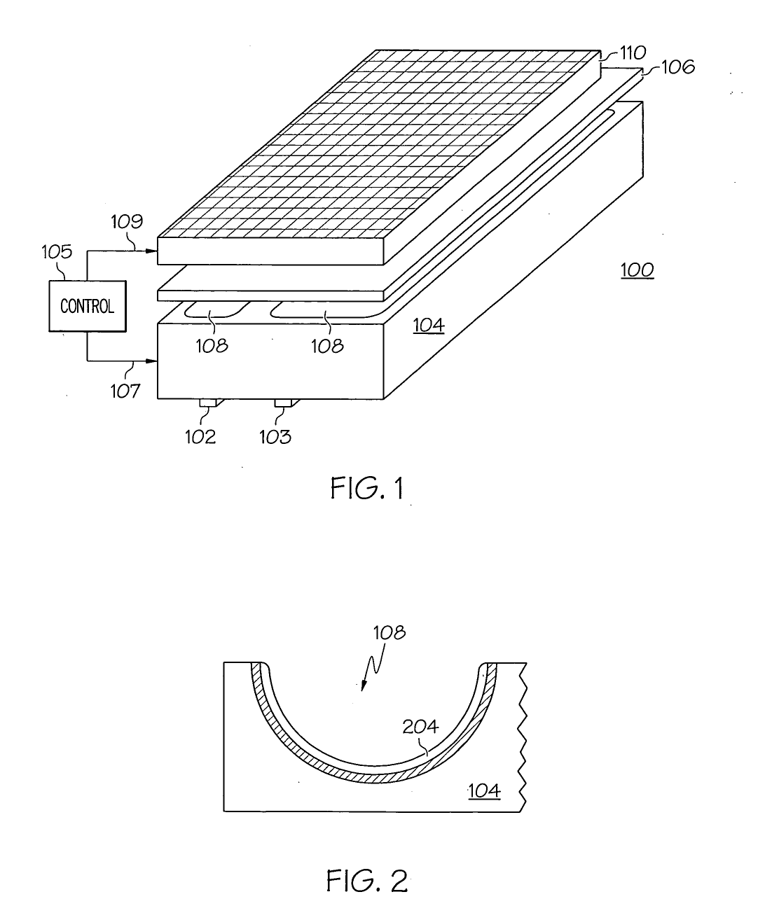

Turning now to the drawing figures and with initial reference to FIG. 1, an exemplary flat panel display 100 suitably includes a backlight assembly with a substrate 104 and a faceplate 106 confining appropriate materials for producing visible light within one or more channels 108. Typically, materials present within channel(s) 108 include argon (or another relatively inert gas), mercury and/or the like. To operate the lamp, an electrical potential is created across the channel 108 (e.g. by coupling electrodes 102, 103 to suitable voltage sources and/or driver circuitry), the gaseous mercury is excited to a higher energy state, resulting in the release of a photon that typically has a wavelength in the ultraviolet light range. This ultraviolet light, in turn, provides “pump” energy to phosphor compounds and/or other light-emitting materials located in the channel to produce light in the visible spectrum that propagates outwardly through faceplate 106 toward pixel array 110.

The light that is produced by backlight assembly 104/106 is appropriately blocked or passed through each of the various pixels of array 110 to produce desired imagery on the display 100. Conventionally, display 100 includes two polarizing plates or films, each located on opposite sides of pixel array 110, with axes of polarization that are twisted at an angle of approximately ninety degrees from each other. As light passes from the backlight through the first polarization layer, it takes on a polarization that would ordinarily be blocked by the opposing film. Each liquid crystal, however, is capable of adjusting the polarization of the light passing through the pixel in response to an applied electrical potential. By controlling the electrical voltages applied to each pixel, then, the polarization of the light passing through the pixel can be “twisted” to align with the second polarization layer, thereby allowing for control over the amounts and locations of light passing from backlight assembly 104/106 through pixel array 110. Most displays 100 incorporate control electronics 105 to activate, deactivate and/or adjust the electrical parameters 109 applied to each pixel. Control electronics 105 may also provide control signals 107 to activate, deactivate or otherwise control the backlight of the display. The backlight may be controlled, for example, by a switched connection between electrodes 102, 103 and appropriate power sources. While the particular operating scheme and layout shown in FIG. 1 may be modified significantly in some embodiments, the basic principals of fluorescent backlighting are applied in many types of flat panel displays 100, including those suitable for use in avionics, desktop or portable computing, audio/video entertainment and/or many other applications.

Fluorescent lamp assembly 104/106 may be formed from any suitable materials and may be assembled in any manner. Substrate 104, for example, is any material capable of at least partially confining the light-producing materials present within channel 108. In various embodiments, substrate 104 is formed from ceramic, plastic, glass and/or the like. The general shape of substrate 104 may be fashioned using conventional techniques, including sawing, routing, molding and/or the like. Further, and as described more fully below, channel 108 may be formed and/or refined within substrate 104 by sandblasting in some embodiments.

Channel 108 is any cavity, indentation or other space formed within or around substrate 104 that allows for partial or entire confinement of light-producing materials. In various embodiments, lamp assembly 104/108 may be fashioned with any number of channels, each of which may be laid out in any manner. Serpentine patterns, for example, have been widely adopted to maximize the surface area of substrate 104 used to produce useful light. U.S. Pat. No. 6,876,139, for example, provides several examples of relatively complicated serpentine patterns for channel 108, although other patterns that are more or less elaborate could be adopted in many alternate embodiments.

With reference now to FIG. 2, channel 108 in substrate 104 is suitably provided with a light-emitting material 202 and a protective layer 204. Channel 108 is appropriately formed in substrate 104 by milling, molding or the like, and light-emitting material 202 is applied though spraying or any other conventional technique. Light-emitting material 202 is typically a phosphorescent compound capable of producing visible light in response to “pump” energy (e.g. ultraviolet light) emitted by vaporous materials confined within channel 108. Various phosphors used in fluorescent lamps include any presently known or subsequently developed light-emitting materials, which may be individually or collectively employed in a wide array of alternate embodiments. Light emitting layer 202 may be applied or otherwise formed in channel 108 using any technique, such as conventional spraying or the like.

An optional protective layer 204 may be provided on light-emitting layer 202 to prevent argon, mercury or other vapor molecules from diffusing into the phosphor or other light-emitting material. When used, protective layer 204 may be made up of any conventional coating material such as aluminum oxide or the like. Alternatively, various embodiments could include a protective layer 204 that includes fused silica (“quartz glass”) or a similar material to prevent mercury penetration into light emitting layer 102.

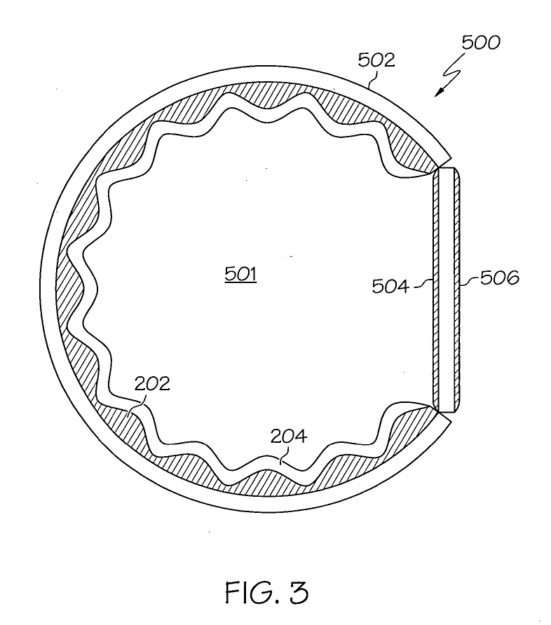

While FIGS. 1 and 2 have been described primarily with respect to a flat fluorescent lamp, these concepts may be equivalently applied in an aperture lamp or the like. The exemplary aperture lamp 500 shown in FIG. 3, for example, suitably includes a light emitting layer 202 that produces visible light in response to UV radiation generated by vaporous materials within channel 501. FIG. 3 also shows the placement of a faceplate or cover 106 with respect to channel 108. Cover 106 is typically made of glass, ceramic glass or plastic, and is suitably attached to substrate 104 by glass fritting or the like in a manner that seals the vaporous materials within channel 108. To further increase the luminous efficiency of lamp 100, a reflective coating 504 or 506 is suitably applied to the internal and/or external face of cover 106 to further increase the efficiency of lamp 100. Reflective coating 504 or 506 is designed to reflect light of certain wavelengths while transmitting light of other wavelengths; for example, coating 504 or 506 may be designed to reflect ultraviolet light back toward channel 108 while allowing visible light to transmit through cover 106 toward pixel array 110 (FIG. 1). Various layers of metals, for example, could provide such functionality, although the particular coatings used to implement reflective layer 504 or 506 vary from embodiment to embodiment.

While FIG. 5 shows coatings 504 and 506 on both sides of faceplate 505 for completeness, in practice only one coating 504 or 506 would likely be present in many embodiments. In “quartz aperture tubes” or other embodiments of lamp 500 in which faceplate 505 is formed of fused silica, for example, a UV reflective coating 506 that is transmissive to longer wavelengths would typically be applied on the outside surface of faceplate 505, opposite channel 501. Conversely, if faceplate 505 is made from soda-lime glass or the like, coating 504 may be applied on the inside surface of the plate to reflect UV radiation toward channel 501 that would otherwise be lost through the aperture. The particular coating 504 applied in this embodiment would be inert to the plasma confined within channel 501, and/or could be covered with a protective layer of fused silica or the like. These coatings 504, 506 may be applied in any appropriate manner, such as sputtering, deposition and/or the like.

To reiterate, then, a fluorescent light source having improved luminous efficiency can be created by adding a suitable reflective layer to the faceplate or cover. Luminous material (e.g. phosphor) is applied in the channel 108 as appropriate, and a coating that is reflective of ultraviolet light yet transmissive of at least certain wavelengths of visible light is applied to the cover. This coating may comprise, for example, one or more metallic layers selected according to the desired optical characteristics of the coating, and applied on the internal and/or external face of the cover as appropriate. The faceplate assembly may then be fitted to the light source substrate by fritting, by using mechanical or chemical fasteners, and/or through any other technique.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims and their legal equivalents.

What is claimed is:

1. A fluorescent light source for providing a visible light, the light source comprising:
a light-producing cavity configured to at least partially enclose a vaporous material that produces an ultra-violet light when electrically excited;
a layer of light-emitting material disposed within at least a portion of the channel that is responsive to the ultra-violet light to produce the visible light;
a faceplate affixed to the cavity to thereby confine the vaporous material, the faceplate comprising a substantially transparent material having a reflective coating disposed thereon, wherein the reflective coating is configured to reflect the ultra-violet light and to transmit the visible light.

2. The light source of claim 1 wherein the reflective coating is disposed on an exterior face of the faceplate opposite the light-producing cavity.

3. The light source of claim 2 wherein the transparent material comprises fused silica.

4. The light source of claim 1 wherein the reflective coating is disposed on an interior side of the faceplate facing toward the light-producing cavity.

5. The light source of claim 4 wherein the faceplate further comprises a layer of fused silica disposed on the interior side of the reflective coating facing toward the light-producing cavity.

6. The light source of claim 5 wherein the transparent material comprises soda-lime glass.

7. The light source of claim 1 wherein the reflective coating comprises at least one layer of metallic material.

8. The light source of claim 2 wherein the reflective coating comprises at least one layer of metallic material.

9. The light source of claim 4 wherein the reflective coating comprises at least one layer of metallic material.

10. A flat panel display incorporating the light source of claim 1.

11. A method of making a fluorescent light source on a substrate having a channel formed therein, the method comprising the steps of:
forming a layer of phosphor material within at least a portion of the channel to thereby create a light-emitting layer;
preparing a faceplate comprising a substantially transparent material with a reflective coating disposed thereon, wherein the reflective coating is substantially transmissive of visible light but substantially reflective of ultraviolet light; and
affixing the faceplate to the channel.

12. The method of claim 11 wherein the reflective coating is disposed on an exterior face of the faceplate opposite the channel.

13. The method of claim 12 wherein the transparent material comprises fused silica.

14. The method of claim 11 wherein the reflective coating is disposed on an interior side of the faceplate facing toward the channel.

15. The method of claim 14 wherein the transparent material comprises soda-lime glass.

16. The light source of claim 11 further comprising the step of forming a layer of fused silica disposed on the interior side of the reflective coating.

17. A fluorescent light source formed by the method of claim 11.

18. A flat panel display comprising a fluorescent light source formed by the method of claim 11.
